(19) United States
(12) Patent Application Publication
(10) Pub. No.: US 2024/0278262 A1
(43) Pub. Date: Aug. 22, 2024

(54) FLUID SPRAY TIPS HAVING SECURING ELEMENTS FORMED IN THE FLUID SPRAY TIP BODY AND METHODS OF MANUFACTURING THEREOF

(71) Applicant: Wagner Spray Tech Corporation, Plymouth, MN (US)

(72) Inventors: Brian Lee FIDELER, Jordan, MN (US); Christopher J. SULZER, St. Louis Park, MN (US); Joseph W. KIEFFER, Chanhassen, MN (US); Mason PASS, Crystal, MN (US)

(21) Appl. No.: 18/440,268

(22) Filed: Feb. 13, 2024

Related U.S. Application Data
(60) Provisional application No. 63/486,274, filed on Feb. 22, 2023.

(51) Int. Cl. B05B 1/04; B05B 7/24; B05B 9/00; B05B 15/65

(52) U.S. Cl. CPC B05B 1/042; B05B 7/2402; B05B 9/007; B05B 15/65

(57) ABSTRACT

A spray tip includes a tip body having a longitudinal axis and a receiving channel extending between a front and back of the tip body transverse to the longitudinal axis. The spray tip further includes a tip piece, a pre-orifice element, and a sealing element between the tip piece and the pre-orifice element, at least the tip piece and the sealing element disposed in the receiving channel, the tip piece defining a first portion of a fluid channel extending from an inlet to an outlet. The spray tip further includes a first securing element downstream of at least a portion of the tip piece and the sealing element and a second securing element upstream of at least a portion of the sealing element and the tip piece, the first securing element and the second securing element securing at least the tip piece and the sealing element within the receiving channel.

### CROSS-REFERENCE TO RELATED APPLICATION

The present application is based on and claims the benefit of U.S. provisional patent application Ser. No. 63/486,274, filed on Feb. 22, 2023, the contents of which are hereby incorporated by reference in their entirety.

### BACKGROUND

Spray tips are typically used in a variety of applications to break up, or atomize, a fluid material for delivery in a desired spray pattern.

While examples described herein are in the context of applying paint to a surface, it is understood that the concepts are not limited to these particular applications. As used herein, paint includes substances composed of coloring matter, or pigments, suspended in a liquid medium as well as substances that are free of coloring matter or pigment. Paint may also include preparatory coatings, such as primers, and can be opaque, transparent, or semi-transparent. Some particular examples include, but are not limited to, latex paint, oil-based paint, stain, lacquers, varnishes, inks, etc.

The discussion above is merely provided for general background information and is not intended to be used as an aid in determining the scope of the claimed subject matter.

### SUMMARY

A spray tip includes a tip body having a longitudinal axis and a receiving channel extending between a front and back of the tip body transverse to the longitudinal axis. The spray tip further includes a tip piece, a pre-orifice element, and a sealing element between the tip piece and the pre-orifice element, at least the tip piece and the sealing element being disposed in the receiving channel, the tip piece defining a first portion of a fluid channel extending from an inlet to an outlet. The spray tip further includes a first securing element downstream of at least a portion of the tip piece and the sealing element and a second securing element upstream of at least a portion of the sealing element and the tip piece, the first securing element and the second securing element securing at least the tip piece and the sealing element within the receiving channel.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a perspective view showing one example fluid application system.

FIG. 2 is a side view showing one example fluid applicator.

FIG. 3 is a perspective view showing one example spray tip.

FIG. 4 is a partial front view showing one example spray tip.

FIGS. 5A-5B are sectional views showing one example spray tip.

FIGS. 6A-6B are sectional views showing one example spray tip.

FIGS. 7A-7B are sectional views showing one example spray tip.

FIGS. 8A-8B are sectional views showing one example spray tip.

FIGS. 9A-9B are sectional views showing one example spray tip.

FIGS. 10A-10B are sectional views showing one example spray tip.

FIGS. 11A-11B are sectional views showing one example spray tip.

FIGS. 12A-12B are sectional views showing one example spray tip.

FIG. 12 is a block diagram showing one example fluid application system in more detail.

FIG. 13 is a flowchart showing one example method of manufacturing a spray tip.

### DETAILED DESCRIPTION OF THE DRAWINGS

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

In a fluid application system, a pump receives and pressurizes a fluid, delivers the pressurized fluid to an applicator, which, in turn, applies the pressurized fluid to a surface using a spray tip having a geometry selected to emit a desired spray pattern (e.g., a round pattern, a flat pattern, or a fan pattern, etc.). The fluid may comprise any fluid applied to surfaces, including, but not limited to, for example, paint, primer, lacquers, foams, textured materials, plural components, adhesive components, etc.

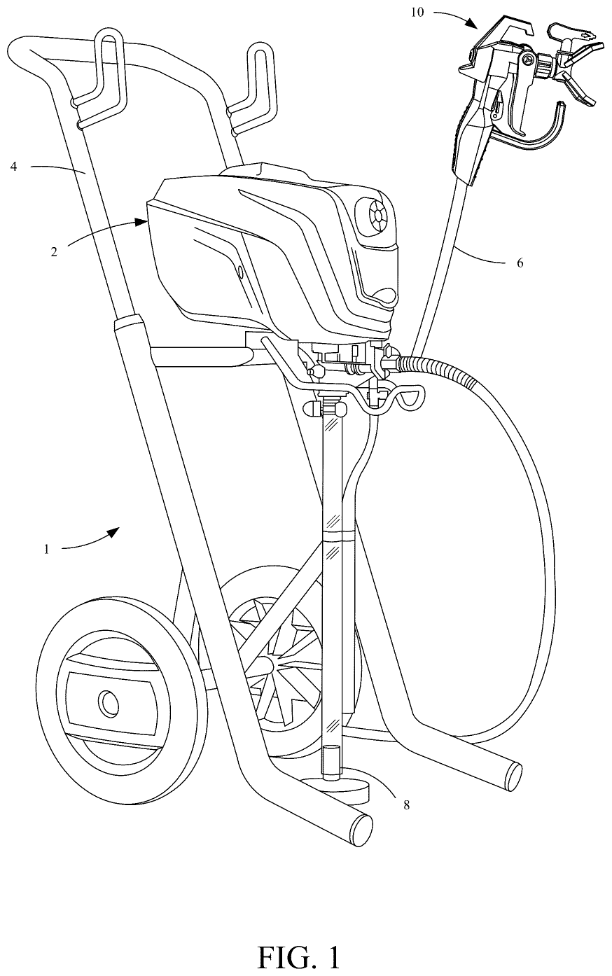

FIG. 1 is a perspective view showing one example fluid application system 1. Fluid application system 1, illustratively shown as an airless fluid spraying system (e.g., a high efficiency airless spraying system), includes pump 2 that is mounted on a cart 4 and couples to applicator 10 through fluid delivery line 6 (e.g., a hose). Pump 2 includes a fluid intake 8 that is disposed within a fluid source (e.g., a five-gallon bucket of paint). Pump 2 pumps the fluid from the fluid source through fluid intake 8 and pumps the fluid at a given pressure to applicator 10 through fluid delivery line 6. In one example, pump 2 can pressurize the fluid between 1500-3500 PSI.

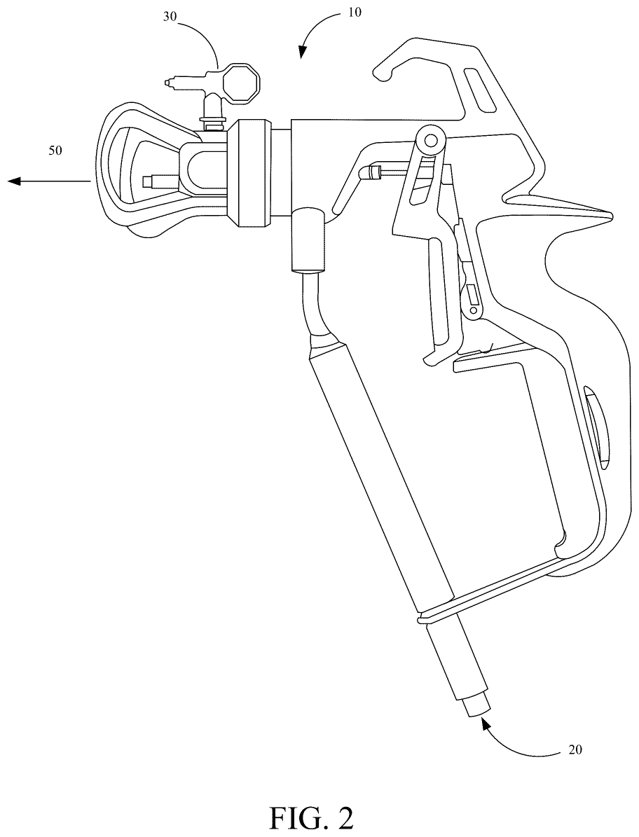

FIG. 2 is a side view showing an example applicator 10. Applicator 10 is used in a fluid spraying system (e.g., fluid application system 1) to apply fluid to a surface (e.g., apply paint to a wall). The fluid enters through inlet 20, and exits from outlet 50, after passing through a fluid channel (not explicitly shown) within applicator 10. Fluid inlet 20 may be coupled to a fluid delivery line, such as fluid delivery line 6. Tip 30 is coupled to applicator 10 and has an outlet 50. Tip 30 often is reversible (e.g., tip 30 can be rotated around its longitudinal axis such that the inlet and outlet are flipped in position (i.e., inlet facing away from applicator 10 and outlet facing towards applicator 10)) or removable from applicator 10. The reversibility of spray tip 30 can help with cleaning.

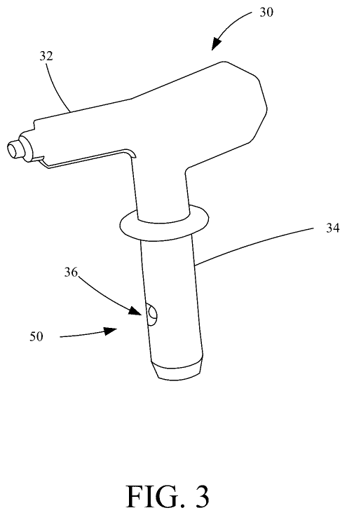

FIG. 3 is a perspective view showing an example spray tip 30. Spray tip 30 includes flag 32, tip stem 34, and receiving channel 36. Flag 32 can be coupled to tip stem 34 in various ways including, for example, but not by limitation, press fitting flag onto tip stem 34 or over molding flag 32 onto tip stem 34. Flag 32 provides a convenient surface for handling spray tip 30, particularly when spray tip 30 is installed in an applicator and can be used to indicate the directionality of spray tip 30. Flag 32 can comprise various materials, for example, polymer. Tip stem 34 can comprise various materials, for example, metal such as stainless steel. A receiving channel 36 can be provided through tip stem 34, such as by machining, cutting, etc. The receiving channel 36 extends a distance between a front of spray tip 30 and a rear (or back) of spray tip 30. In some examples, the receiving channel 36 may extend from a front of spray tip 30 to a rear of spray tip 30 and yet, in other examples, the receiving channel 36 may extend some other distance. The receiving channel 36 will be shown in more detail below.

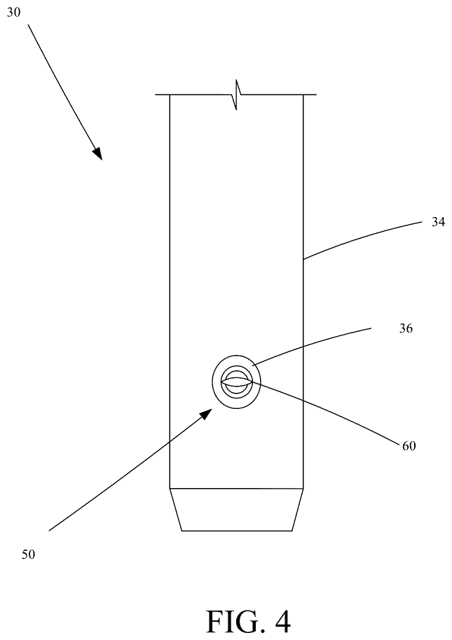

FIG. 4 is a partial front view showing example spray tip 30. As illustrated in FIG. 4, a tip piece 60 can be placed and retained within receiving channel 36. As will be shown in more detail in figures below, various other items can be placed and retained within a receiving channel of a spray tip.

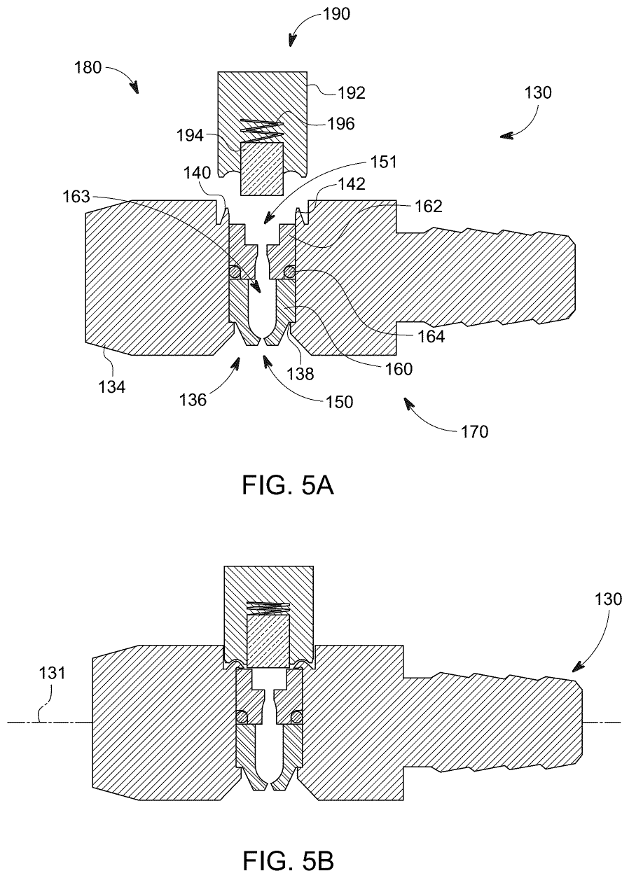

FIGS. 5A-11B are cross-sectional views showing example spray tips. It will be understood that the spray tips illustrated in FIGS. 5A-11B are example embodiments of spray tip 30 and can thus be used with a fluid applicator, such as fluid applicator 10, and in a fluid applicator system, such as fluid application system 1. It will be noted that the example spray tips shown in FIGS. 5A-11B have their respective flags removed for convenience of illustration, but it will be understood that each of the example spray tips can include a flag, such as flag 32.

FIGS. 5A-5B (collectively referred to herein as FIG. 5) are cross-sectional views showing example spray tip 130. As illustrated in FIG. 5, spray tip 130 includes tip stem 134 with a receiving channel 136 provided therein, transverse to the longitudinal axis 131 of the tip stem 134. Receiving channel 136 extends between a front 170 of spray tip 130 and a back 180 of spray tip 130. It can be seen in FIG. 5 that a tip piece 160, a pre-orifice element in the form of a pre-orifice piece 162, and a sealing element 164 are placed within receiving channel 136 from the back 180 of spray tip 130 and are retained within receiving channel 136. The geometry of receiving channel 136 forms a shoulder 138 against which an outer surface of tip piece 160 abuts. Sealing element 164 (illustratively an O-ring) fits around pre-orifice piece 162 (a portion of pre-orifice piece 162 is disposed within a hole of sealing element 164). Sealing element 164 abuts an outer surface of pre-orifice piece 162, an outer surface of tip piece 160, and a wall of receiving channel 136. An outer surface of pre-orifice piece 162 abuts an outer surface of tip piece 160. Tip piece 160 and pre-orifice piece 162 form a fluid channel 163 having variable geometry extending from an inlet 151 to an outlet 150. Fluid, to be sprayed, is received though the inlet 151 and exits through the outlet 150. A recess 140 is provided from and in to the back 180 of spray tip 130 which forms an annular projection 142.

A swaging tool 190 is provided. Swaging tool 190 includes a swaging body 192, a biased member 194, and a biasing member 196. In the illustrated example, biasing member 196 is a spring. Swaging tool 190 is pressed, from the back 180 of spray tip 130, against spray tip 130 such that biased member 194 contacts pre-orifice portion 162, and such that swaging body 192 fits within recess 140 and contacts annular projection 142 to deform (or crimp) annular projection 142 against pre-orifice piece 162. Biased member 194 contacts pre-orifice portion 162 and drives pre-orifice portion 162 to and against sealing element 164 and thereby crushes sealing element 164 such that sealing element 164 forms a seal against an outer surface of pre-orifice piece 162, a seal against an outer surface of tip piece 160, and a seal against a wall of receiving channel 136. The deformed annular projection 142 (shown in FIG. 5B) and the shoulder 138 retain pre-orifice portion 162, sealing element 164, and tip piece 160 within receiving channel 136.

In one example, tip piece 160 can be formed of a metal, such as carbide. In one example, pre-orifice piece 162 can be formed of a metal, such as carbide or stainless steel, such as hardened stainless steel. In one example, sealing element 164 can be formed of a polymer, such as an elastomer (e.g., rubber, etc.).

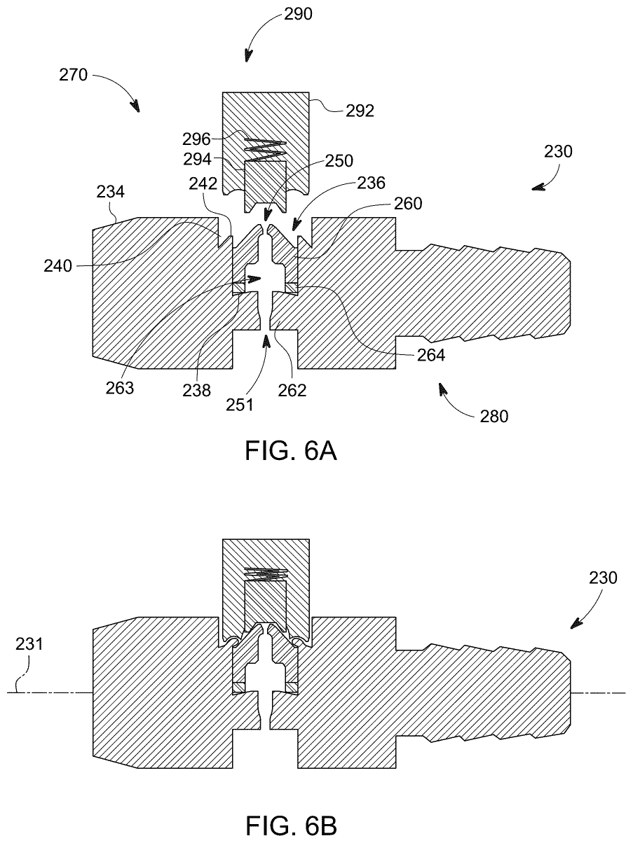

FIG. 6A-6B (collectively referred to herein as FIG. 6) are cross-sectional views showing example spray tip 230. As illustrated in FIG. 6, spray tip 230 includes tip stem 234 with a receiving channel 236 provided therein, transverse to the longitudinal axis 231 of the tip stem 234. Receiving channel 236 extends from a front 270 to a pre-orifice element in the form of a pre-orifice portion 262. Pre-orifice portion 262 is formed within tip stem 234, such as by machining, and includes a shoulder 238. It can be seen in FIG. 6 that a tip piece 260 and a sealing element 264 are placed within receiving channel 236 from the front 270 of spray tip 230 and are retained within receiving channel 236. Sealing element 264 (illustratively a gasket) abuts shoulder 238, an outer surface of tip piece 260, and a wall of receiving channel 236. Tip piece 260, pre-orifice portion 262, and sealing element 264 form a fluid channel 263 having variable geometry extending from an inlet 251 to an outlet 250. Fluid, to be sprayed, is received through inlet 251 and exits through outlet 250. A recess 240 is provided from and in the front 270 of spray tip 230 which forms an annular projection 242.

A swaging tool 290 is provided. Swaging tool 290 includes a swaging body 292, a biased member 294, and a biasing member 296. In the illustrated example, biasing member 296 is a spring. Swaging tool 290 is pressed, from the front 270 of spray tip 230, against spray tip 230 such that biased member 294 contacts tip piece 260 and such that swaging body 292 fits within recess 240 and contacts annular projection 242 to deform (or crimp) annular projection 242 against tip piece 260. Biased member 294 contacts tip piece 260 and drives tip piece 260 to and against sealing element 264 and thereby crushes sealing element 264 such that sealing element 264 forms a seal against an outer surface or tip piece 260, a seal against shoulder 238, and a seal against a wall of receiving channel 236. The deformed annular projection 242 (shown in FIG. 6B) and shoulder 238 retain tip piece 260 and sealing element 264 within receiving channel 236. As can be seen in FIG. 6, biased member 294 is shaped to fit around a portion of tip piece 260.

In one example, tip piece 260 can be formed of a metal, such as carbide. In one example, pre-orifice portion 262 (as well as tip stem 234) can be formed of stainless steel, such as hardened stainless steel. In one example, sealing element 264 can be formed of a polymer, such as plastic or an elastomer (e.g., rubber, etc.).

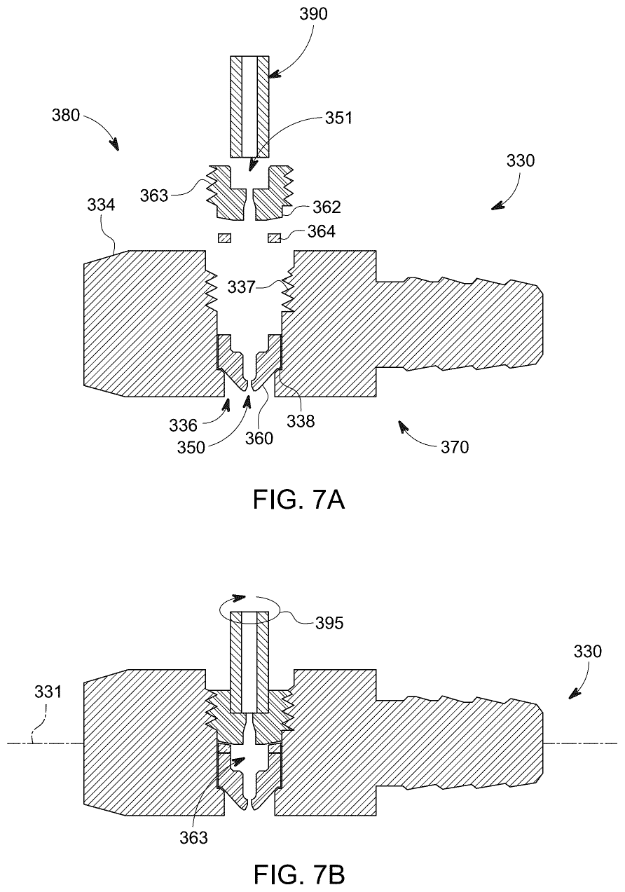

FIGS. 7A-7B (collectively referred to herein as FIG. 7) are cross-sectional views showing example spray tip 330. As illustrated in FIG. 7, spray tip 330 includes tip stem 334 with a receiving channel 336 provided therein, transverse to the longitudinal axis 331 of the tip stem 334. Receiving channel 336 extends between a front 370 of spray tip 330 and a back 380 of spray tip 330. It can be seen in FIG. 7 that a tip piece 360, a pre-orifice element in the form of a pre-orifice piece 362, and a sealing element 364 are placed within receiving channel 336 from the back 380 of spray tip 330 and are retained within receiving channel 336. The geometry of receiving channel 336 forms a shoulder 338 against which an outer surface of tip piece 360 abuts. Sealing element 364 (illustratively a gasket) abuts an outer surface of pre-orifice piece 362, an outer surface of tip piece 360, and a wall of receiving channel 336. Tip piece 360, pre-orifice portion 362, and sealing element 364 form a fluid channel 363 having variable geometry extending from an inlet 351 to an outlet 350. Fluid, to be sprayed, is received though the inlet 351 and exits through the outlet 350. As can be seen in FIG. 7, receiving channel 336 is provided with threads 337 and pre-orifice piece 362 is provided with threads 363. Threads 363 and threads 337 mate.

A rotatable driving tool 390 is provided. In the illustrated example, rotatable driving tool 390 is provided, from the back 380 of spray tip 330, and into the fluid channel of pre-orifice piece 362. Rotatable driving tool 390, while disposed within the fluid channel of pre-orifice piece 362, is rotated, as indicated by arrow 395, to drive pre-orifice piece 362 within receiving channel 336, via threads 363 and 337, towards sealing element 364 and to contact and crush sealing element 364 such that sealing element 364 forms a seal against an outer surface of pre-orifice piece 362, a seal against an outer surface of tip piece 360, and a seal against a wall of receiving channel 336. The threaded connection between pre-orifice piece 362 and receiving channel 336 (shown in FIG. 7B) retains pre-orifice piece 362 within receiving channel 336. Thus, tip piece 360, pre-orifice portion 362, and sealing element 364 are retained within receiving channel 336 by shoulder 338 and the threaded connection between pre-orifice piece 362 and receiving channel 336 (as shown in FIG. 7B).

In one example, tip piece 360 can be formed of a metal, such as carbide. In one example, pre-orifice piece 362 can be formed of a metal, such as stainless steel, for instance hardened stainless steel. In one example, pre-orifice piece 362 is a set screw, such as a hardened stainless steel set screw. In one example, sealing element 364 can be formed of a polymer, such as plastic or an elastomer (e.g., rubber, etc.).

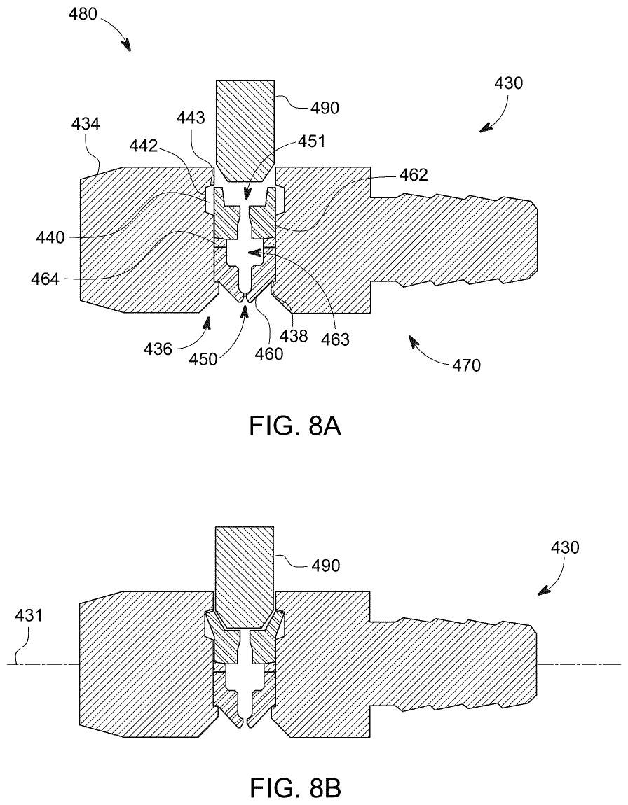

FIGS. 8A-8B (collectively referred to herein as FIG. 8) are cross-sectional views showing example spray tip 430. As illustrated in FIG. 8, spray tip 430 includes tip stem 434 with a receiving channel 436 provided therein, transverse to the longitudinal axis 431 of the tip stem 434. Receiving channel 436 extends between a front 470 of spray tip 430 and a back 480 of spray tip 430. It can be seen in FIG. 8 that a tip piece 460, a pre-orifice element in the form of a pre-orifice piece 462, and a sealing element 464 are placed within receiving channel 436 from the back 480 of spray tip 430 and are retained within receiving channel 436. The geometry of receiving channel 436 forms a shoulder 438 against which an outer surface of tip piece 460 abuts. Sealing element 464 (illustratively a gasket) abuts an outer surface of pre-orifice piece 462, an outer surface of tip piece 460, and a wall of receiving channel 436. Tip piece 460, pre-orifice portion 462, and sealing element 464 form a fluid channel 463 having variable geometry extending from an inlet 451 to an outlet 450. Fluid, to be sprayed, is received though the inlet 451 and exits through the outlet 450. As can be seen in FIG. 8, tip stem 434 is provided with a recess 440 that extends radially from receiving channel 436 and forms a shoulder 443.

A press tool 490 is provided. In the illustrated example, press tool 490 is provided, from the back 480 of spray tip 430, and into the fluid channel of pre-orifice piece 462. Press tool 490, while disposed within the fluid channel of pre-orifice piece 462, is driven to press pre-orifice piece 462 towards and against sealing element 464 to crush sealing element 464 such that sealing element 464 forms a seal against an outer surface of pre-orifice piece 462, a seal against an outer surface of tip piece 460, and a seal against a wall of receiving channel 436. Insertion of the press tool 490 into the fluid channel of pre-orifice piece 462 deforms a wall 442 of pre-orifice piece 462 such that pre-orifice portion 462 expands in diameter and is disposed within recess 440 and abuts shoulder 443 (as shown in FIG. 8B). Thus, tip piece 460, pre-orifice portion 462, and sealing element 464 are retained within receiving channel 436 by shoulder 438 and the contact between the deformed wall 442 (shown in FIG. 8B) of pre-orifice piece 462 and the shoulder 443.

In one example, tip piece 460 can be formed of a metal, such as carbide. In one example, pre-orifice piece 462 can be formed of a metal, such as stainless steel. In one example, sealing element 464 can be formed of a polymer, such as plastic or an elastomer (e.g., rubber, etc.).

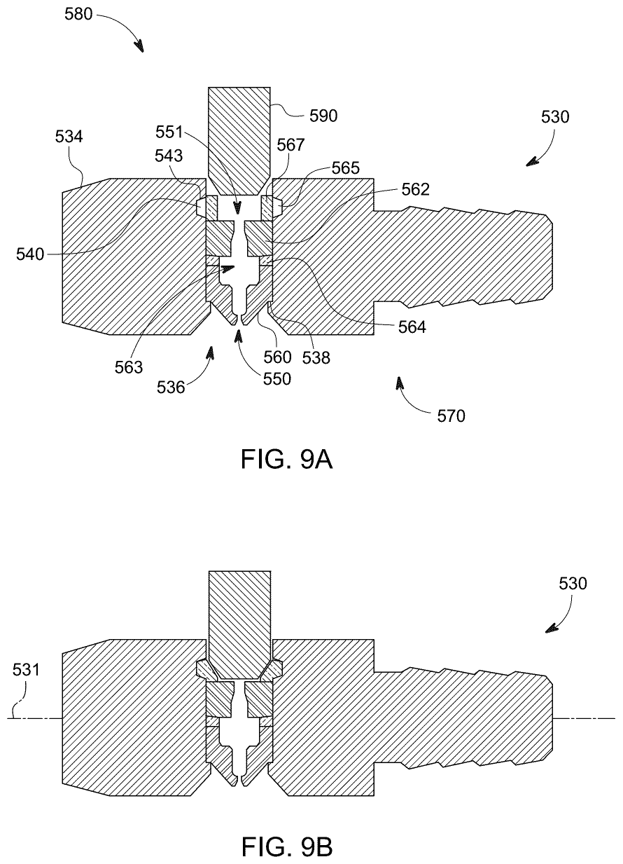

FIGS. 9A-9B (collectively referred to herein as FIG. 9) are cross-sectional views showing example spray tip 530. As illustrated in FIG. 9, spray tip 530 includes tip stem 534 with a receiving channel 536 provided therein, transverse to the longitudinal axis 531 of the tip stem 534. Receiving channel 536 extends between a front 570 of spray tip 530 and a back 580 of spray tip 530. It can be seen in FIG. 9 that a tip piece 560, a pre-orifice element in the form of a pre-orifice piece 562, a sealing element 564, and a retaining ring 565 are placed within receiving channel 536 from the back 580 of spray tip 530 and are retained within receiving channel 536. The geometry of receiving channel 536 forms a shoulder 538 against which an outer surface of tip piece 560 abuts. Sealing element 564 (illustratively a gasket) abuts an outer surface of pre-orifice piece 562, an outer surface of tip piece 560, and a wall of receiving channel 536. Tip piece 560, pre-orifice portion 562, and sealing element 564 form a fluid channel 563 having variable geometry extending from an inlet 551 to an outlet 550. Fluid, to be sprayed, is received though the inlet 551 and exits through the outlet 550. As can be seen in FIG. 9, tip stem 534 is provided with a recess 540 which extends radially from receiving channel 536 and forms a shoulder 543. Retaining ring 565, when installed, abuts pre-orifice piece 562.

A press tool 590 is provided. In the illustrated example, press tool 590 is provided, from the back 580 of spray tip 530, and into a hole of retaining ring 565. Press tool 590, while disposed within the hole of retaining ring 565, is driven to press retaining ring 565 towards and against pre-orifice portion 562 which drives pre-orifice portion 562 towards and against sealing element 564 to crush sealing element 564 such that sealing element 564 forms a seal against an outer surface of pre-orifice piece 562, a seal against an outer surface of tip piece 560, and a seal against a wall of receiving channel 536. Insertion of the press tool 590 into the hole of retaining ring 565 deforms a wall 567 of retaining ring 565 such that retaining ring 565 expands in diameter and is disposed within recess 540 and abuts shoulder 543 (as shown in FIG. 9B). Thus, tip piece 560, pre-orifice portion 562, sealing element 564, and retaining ring 565 are retained within receiving channel 536 by shoulder 538 and the contact between the deformed wall 567 (shown in FIG. 9B) of retaining ring 565 and the shoulder 543.

In one example, tip piece 560 can be formed of a metal, such as carbide. In one example, pre-orifice piece 562 can be formed of a metal, such as carbide or stainless steel, such as hardened stainless steel. In one example, sealing element 564 can be formed of a polymer, such as plastic or an elastomer (e.g., rubber, etc.). In one example, retaining ring 565 can be formed of metal, such as stainless steel, for instance hardened stainless steel.

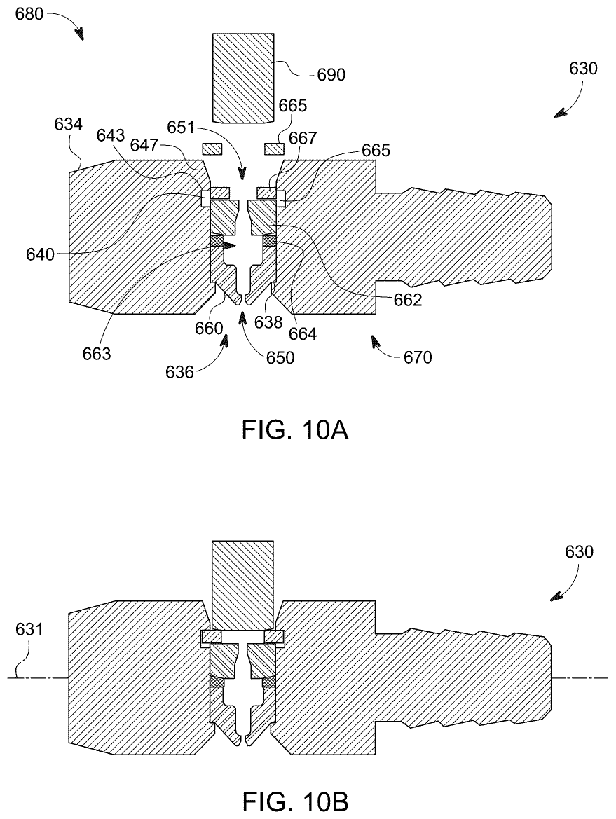

FIGS. 10A-10B (collectively referred to herein as FIG. 10) are cross-sectional views showing one example spray tip 630. As illustrated in FIG. 10, spray tip 630 includes tip stem 634 with a receiving channel 636 provided therein, transverse to the longitudinal axis 631 of the tip stem 634. Receiving channel 636 extends between a front 670 of spray tip 630 and a back 680 of spray tip 630. It can be seen in FIG. 10 that a tip piece 660, a pre-orifice element in the form of a pre-orifice piece 662, a sealing element 664, and a snap ring 665 are placed within receiving channel 636 from the back 680 of spray tip 630 and are retained within receiving channel 636. The geometry of receiving channel 636 forms a shoulder 638 against which an outer surface of tip piece 660 abuts. Sealing element 664 (illustratively a gasket) abuts an outer surface of pre-orifice piece 662, an outer surface of tip piece 660, and a wall of receiving channel 636. Tip piece 660, pre-orifice portion 662, and sealing element 664 form a fluid channel 663 having variable geometry extending from an inlet 651 to an outlet 650. Fluid, to be sprayed, is received though the inlet 651 and exits through the outlet 650. As can be seen in FIG. 10, tip stem 634 is provided with a recess 640 which extends radially from receiving channel 636 and forms a shoulder 643. Receiving channel 636 further includes a ramp 647 which narrows as it extends from the back 680 of spray tip 630 towards the front 670 of spray tip 630. Snap ring 665, when installed, abuts pre-orifice piece 662.

A press tool 690 is provided. In the illustrated example, press tool 690 is provided, from the back 680 of spray tip 630, and into a hole of snap ring 665. Press tool 690, while disposed within the hole of snap ring 665, is driven to press and drive snap ring 665 along ramp 647 towards and against pre-orifice portion 662 which drives pre-orifice portion 662 towards and against sealing element 664 to crush sealing element 664 such that sealing element 664 forms a seal against an outer surface of pre-orifice piece 662, a seal against an outer surface of tip piece 660, and a seal against a wall of receiving channel 636. Driving snap ring 665 along ramp 647 progressively reduces the diameter of snap ring 665 until snap ring 665 passes ramp 647 at which point snap ring 665 snaps back to its original (or at least a wider) diameter and is thus disposed within recess 640 and abuts shoulder 643 (as shown in FIG. 10B). Thus, tip piece 660, pre-orifice portion 662, sealing element 664, and snap ring 665 are retained within receiving channel 636 by shoulder 638 and the contact between snap ring 665 and the shoulder 643.

In one example, tip piece 660 can be formed of a metal, such as carbide. In one example, pre-orifice piece 662 can be formed of a metal, such as carbide or stainless steel, such as hardened stainless steel. In one example, sealing element 664 can be formed of a polymer, such as plastic or an elastomer (e.g., rubber, etc.). In one example, snap ring 665 can be formed of metal, such as stainless steel, for instance hardened stainless steel.

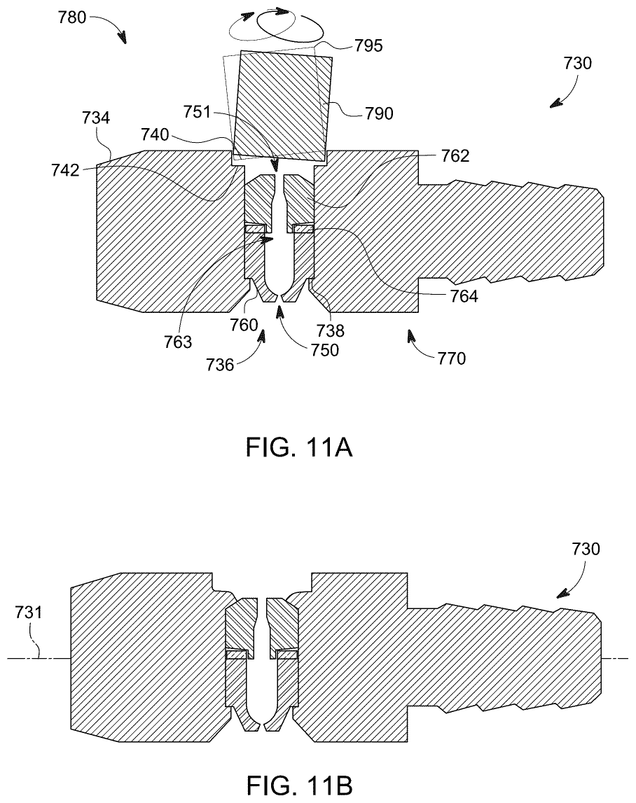

FIGS. 11A-11B (collectively referred to herein as FIG. 11) are cross-sectional views showing example spray tip 730. As illustrated in FIG. 11, spray tip 730 includes tip stem 734 with a receiving channel 736 provided therein, transverse to the longitudinal axis 731 of the tip stem 734. Receiving channel 736 extends between a front 770 of spray tip 730 and a back 780 of spray tip 730. It can be seen in FIG. 11 that a tip piece 760, a pre-orifice element in the form of a pre-orifice piece 762, and a sealing element 764 are placed within receiving channel 736 from the back 780 of spray tip 730 and are retained within receiving channel 736. The geometry of receiving channel 736 forms a shoulder 738 against which an outer surface of tip piece 760 abuts. Sealing element 764 fits around pre-orifice piece 762 (a portion of pre-orifice piece 762 is disposed within a hole of sealing element 764). Sealing element 764 comprises a ductile or elastomeric material such as a polymer (e.g., acetal, etc.) or various other ductile or elastomeric materials. Sealing element 764 abuts an outer surface of pre-orifice piece 762, abuts an outer surface of tip piece 760, and abuts a wall of receiving channel 736. Tip piece 760 and pre-orifice piece 762 form a fluid channel 763 having variable geometry extending from an inlet 751 to an outlet 750. Fluid, to be sprayed, is received though the inlet 751 and exits through the outlet 750. A recess 740 is provided from and in the back 780 of spray tip 730 which forms an annular wall 742.

A peen tool 790 is provided (as part of an orbital forming machine). Peen tool 790 is used, in an orbital forming process, to deform annular wall 742. Peen tool 790 is pressed, from the back 780 of spray tip 730, against spray tip 730 such that peen tool 790 fits within recess 740, contacts annular wall 742 to deform (or crimp) annular wall 742 against pre-orifice piece 762 (as shown in FIG. 11B). Peen tool 790 is caused to actuate in a circular, or orbital, motion (as indicated by arrow 795) to progressively collapse (deform or crimp) annular wall 742 against pre-orifice piece 762. The deformation (or crimping) of annular wall 742 against pre-orifice piece 762 drives pre-orifice piece 762 to and against sealing element 764 and thereby crushes sealing element 764 such that sealing element 764 forms a seal against an outer surface of pre-orifice piece 762, a seal against an outer surface of tip piece 760, and a seal against a wall of receiving channel 736. The deformed annular wall 742 (shown in FIG. 11B) and the shoulder 738 retain pre-orifice piece 762, sealing element 764, and tip piece 760 within receiving channel 736.

In one example, tip piece 760 can be formed of a metal, such as carbide. In one example, pre-orifice piece 762 can be formed of a metal, such as carbide or stainless steel, such as hardened stainless steel. In one example, sealing element 764 can be formed of a polymer, such as an elastomer (e.g., rubber, etc.).

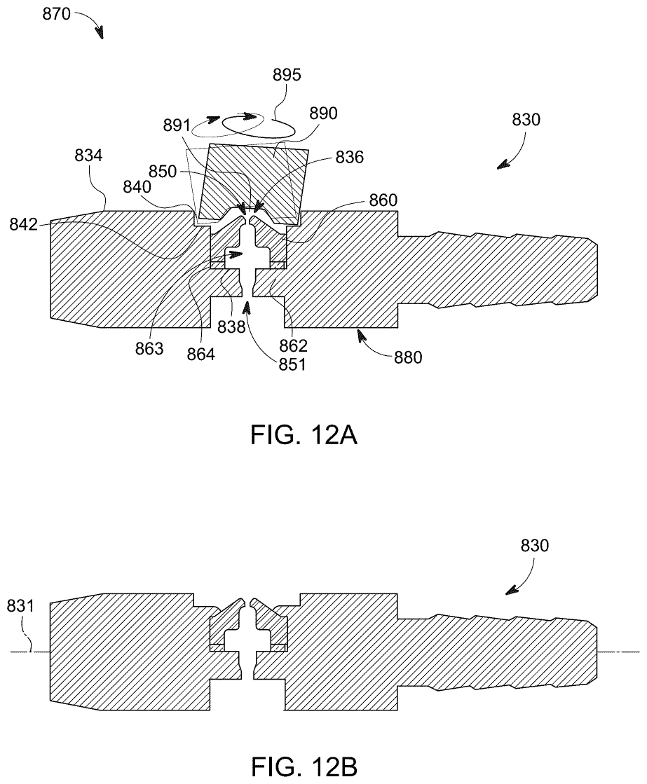

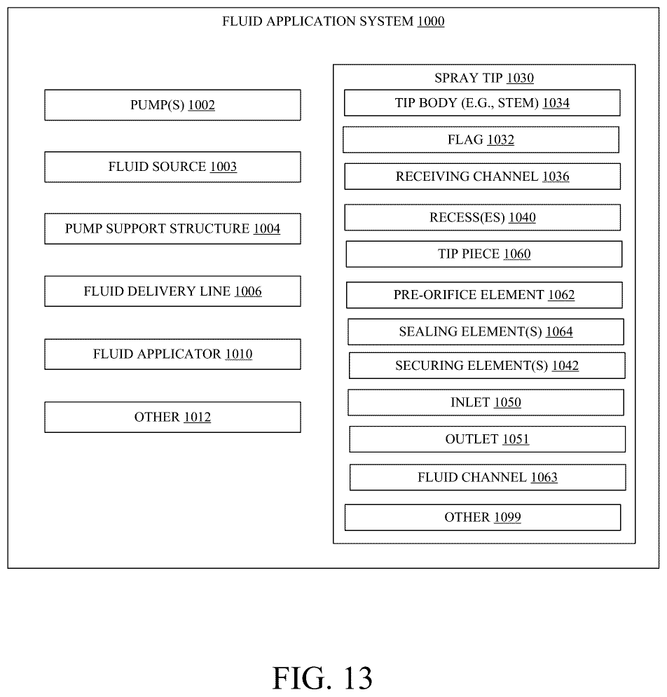

FIGS. 12A-12B (collectively referred to herein as FIG. 12) are cross-sectional views showing example spray tip 830. As illustrated in FIG. 12, spray tip 830 includes tip stem 834 with a receiving channel 836 provided therein, transverse to the longitudinal axis 831 of the tip stem 834. Receiving channel 836 extends between a front 870 of spray tip 830 to a pre-orifice element in the form of a pre-orifice portion 862. Pre-orifice portion 862 is formed within tip stem 834, such as by machining. It can be seen in FIG. 12 that a tip piece 860 and a sealing element 864 are placed within receiving channel 836 from the front 870 of spray tip 830 and are retained within receiving channel 836. The geometry of receiving channel 836 forms a shoulder 838. Sealing element 864 abuts shoulder 838, an outer surface of tip piece 860, and a wall of receiving channel 836. Sealing element 864 comprises a ductile or elastomeric material such as a polymer (e.g., acetal, etc.) or various other ductile or elastomeric materials. Tip piece 860. sealing element 864, and pre-orifice portion 862 form a fluid channel 863 having variable geometry extending from an inlet 851 to an outlet 850. Fluid, to be sprayed, is received though the inlet 851 and exits through the outlet 850. A recess 840 is provided from and in the front 880 of spray tip 830 which forms an annular wall 842.

A peen tool 890 is provided (as part of an orbital forming machine). Peen tool 890 is similar to peen tool 790 except that peen tool 890 includes a recess configured to receive a portion of tip piece 860. Peen tool 890 is used, in an orbital forming process, to deform annular wall 842. Peen tool 890 is pressed, from the front 870 of spray tip 830, against spray tip 830 and against tip piece 860 such that peen tool 890 fits within recess 840, contacts annular wall 842 to deform (or crimp) annular wall 842 against tip piece 860 (as shown in FIG. 12B). Peen tool 890 is caused to actuate in a circular, or orbital, motion (as indicated by arrow 895) to progressively collapse (deform or crimp) annular wall 842 against tip piece 860. The deformation (or crimping) of annular wall 842 against tip piece 860 drives tip piece 860 to and against sealing element 864 and thereby crushes sealing element 864 such that sealing element 864 forms a seal against an outer surface of pre-orifice element 862 or shoulder 838, a seal against an outer surface of tip piece 760, and a seal against a wall of receiving channel 836. The deformed annular wall 842 (shown in FIG. 12B) and the shoulder 838 retain tip piece 860 and sealing element 864 within receiving channel 836.

In one example, tip piece 860 can be formed of a metal, such as carbide. In one example, pre-orifice piece 862 can be formed of a metal, such as carbide or stainless steel, such as hardened stainless steel. In one example, sealing element 864 can be formed of a polymer, such as an elastomer (e.g., rubber, etc.).

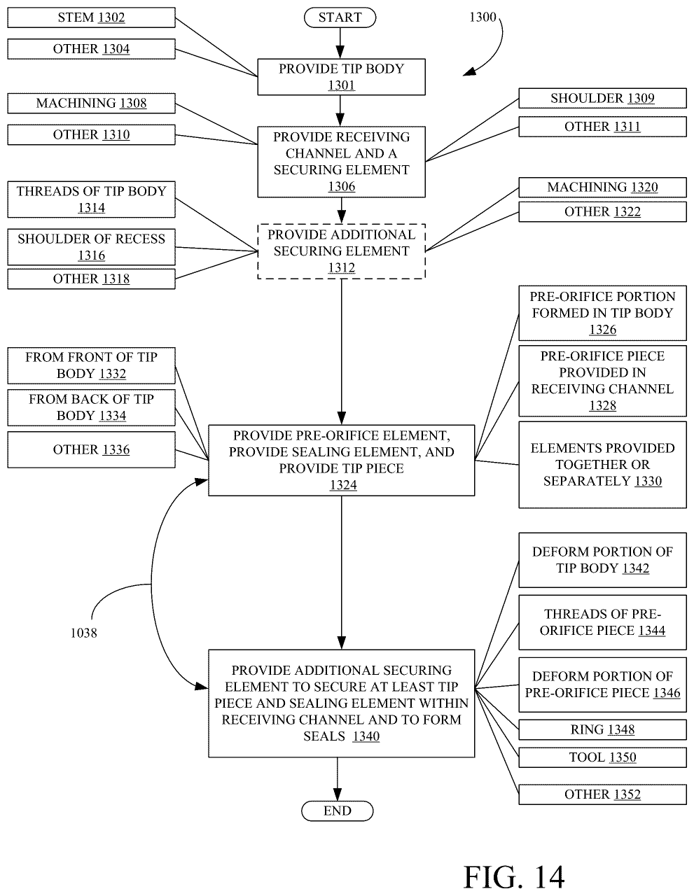

FIG. 13 is a block diagram showing one example fluid application system 1000. Fluid application system 1000 can include one or more pumps 1002, a fluid source 1003, a pump support structure 1004, a fluid delivery line 1006, a fluid applicator 1010, a spray tip 1030, and can include various other items 1012, including, but not limited to, other items discussed or shown herein.

Pumps 1002, in one example, can be similar to pump 2, or can be other type of pumps. A fluid source 1003 can be a fluid container, such as a paint bucket (e.g., 5-gallon paint bucket, etc.). Pump support structure 1004 can be similar to cart 4 or can be other types of pump support structures. Fluid delivery line 1006 can be similar to fluid delivery line 6 or can be another type of fluid delivery line. Fluid applicator 1010 can be similar to fluid applicator 10 or can be another type of fluid applicator. Pumps 1002 pump and pressurize fluid from fluid source 1003 and deliver the pressurized fluid to fluid applicator 1010 via fluid delivery line 1006. The pumps 1002 can be supported by a pump support structure 1004, such as a cart (e.g., 4) or other pump support structure.

Spray tip 1030 is installed in fluid applicator 1010. Spray tip 1030 can be similar to spray tip 30, spray tip 130, spray tip 230, spray tip 330, spray tip 430, spray tip 530, spray tip 630, spray tip 730, or spray tip 830, or can be another type of spray tip. Pressurized fluid is delivered through fluid applicator to spray tip 1030. Spray tip 1030 breaks up, or atomizes, the fluid to deliver the fluid in a desired spray pattern.

Spray tip 1030 can include a tip body (or stem) 1034, a flag 1032, a receiving channel 1036, one or more recesses 1040, a tip piece 1060, a pre-orifice element 1062, one or more sealing elements 1064, one or more securing elements 1042, an outlet 1050, an inlet 1051, a fluid channel 1063, and can include various other items 1099 as well, including but not limited to, other items discussed or shown herein.

Tip body (or stem) 1034 can be similar to stem 34, stem 134, stem 234, stem 334, stem 434, stem 534, stem 634, stem 734, or stem 834, or can be another type of tip body (or stem). Flag 1032 can be similar to flag 32 or can be another type of flag. Receiving channel 1036 can be similar to receiving channel 36, receiving channel 136, receiving channel 236, receiving channel 336, receiving channel 436, receiving channel 536, receiving channel 636, receiving channel 736, or receiving channel 836, or can be another type of receiving channel.

Recesses 1040 can be similar to recess 140, recess 240, recess 440, recess 540, recess 640, recess 740, or recess 840, or can be another type of recess or other types of recesses.

Tip piece 1060 can be similar to tip piece 60, tip piece 160, tip piece 260, tip piece 360, tip piece 460, tip piece 560, tip piece 660, tip piece 760, or tip piece 860, or can be another type of tip piece. Pre-orifice element 1062 can be similar to pre-orifice piece 162, pre-orifice portion 262, pre-orifice piece 362, pre-orifice piece 462, pre-orifice piece 562, pre-orifice piece 662, pre-orifice piece 762, or pre-orifice portion 262, or can be another type of pre-orifice element. Sealing elements can be similar to sealing element 164, sealing element 264, sealing element 364, sealing element 464, sealing element 564, sealing element 664, sealing element 764, or sealing element 864, or can be another type of sealing element or other types of sealing elements.

Securing elements 1042 can be similar to shoulder 138 and deformed projections 142, to shoulder 238 and deformed projections 242, to mating threads 363, mating threads 337 and shoulder 338, to shoulder 438, shoulder 443, and deformed wall 442, to shoulder 538, shoulder 543, and ring 565, to shoulder 638, shoulder 643, and ring 665, to shoulder 738 and deformed wall 742, or to should 838 and deformed wall 842, or another type of securing element or other types of securing elements.

Outlet 1050 can be similar to outlet 50, outlet 150, outlet 250, outlet 350, outlet 450, outlet 550, outlet 650, outlet 750, or outlet 850, or another type of outlet. Inlet 1051 can be similar to inlet 151, inlet 251, inlet 351, inlet 451, inlet 551, inlet 651, inlet 751, or inlet 851, or can be another type of inlet. Fluid channel 1063 can be similar to fluid channel 136, fluid channel 236, fluid channel 336, fluid channel 436, fluid channel 536, fluid channel 636, fluid channel 736, or fluid channel 836, or another type of fluid channel. Fluid channel 1036 extends between inlet 1051 and outlet 1050 and can have variable geometry. In some examples, fluid channel 1036 can be stepped, or can otherwise progressively widen from an upstream end to a downstream point and then progressively narrow from the downstream point to a downstream end.

It will be understood that spray tip 1030 can be reversible (e.g., can be rotated about its longitudinal axis). That is, the spray tip can be rotated between a first operating posture (normal operation posture) in which the outlet 1050 is facing away from the applicator 1010 and inlet 1051 is facing towards the applicator 1010 and a second operating posture (cleaning operation posture) in which the outlet is facing towards the applicator 1010 and the inlet is facing away from the applicator 1010.

FIG. 14 shows a flowchart showing one example method 1300 of manufacturing a spray tip, such as spray tip 1030.

At block 1301 a tip body 1034 is provided. As indicated by block 1302, the tip body 1034 can be a stem, such as stem 34, stem 134, stem 234, stem 334, stem 434, stem 534, stem 634, stem 734, or stem 834, or another type of stem. The tip body 1034 can be other types of tip bodies, as indicated by block 1304.

At block 1306, at receiving channel 1036 and a securing element 1042 is provided in tip body 1034. The receiving channel 1036 can be receiving channel 36, receiving channel 136, receiving channel 236, receiving channel 336, receiving channel 436, receiving channel 536, receiving channel 636, receiving channel 736, or receiving channel 836, or another type of receiving channel. In some examples, the receiving channel 1036 is transverse to a longitudinal axis of the tip body 1034. The securing element 1042 at block 1306 can be shoulder 138, shoulder 238, shoulder 338, shoulder 438, shoulder 538, shoulder 638, shoulder 738, or shoulder 838, or can be another type of securing element. In some examples, providing the receiving channel 1036 also provides the securing element 1042 at block 1306, for instance, the geometry of the receiving channel 1036 may define the securing element 1042 at block 1306. As indicated by block 1308, the receiving channel or the securing element 1042, at block 1306, can be provided by machining. As indicated by block 1310, the receiving channel or the securing element 1042, at block 1306, can be provided in various other ways.

In some examples, an additional securing element 1042 is provided at block 1312. As indicated by block 1314, the additional securing element 1042 can be threads formed in the tip body 1034. The threads can be threads 337, or can be other threads. As indicated by block 1316, the additional securing element 1042 can be a shoulder of a recess formed in the tip body 1034. The shoulder of the recess can be shoulder 443 of recess 440, shoulder 543 of recess 540, or shoulder 643 of recess 640, or can be another shoulder of another recess. The additional securing element 1042 can be various other securing elements, as indicated by block 1318. As indicated by block 1320, the additional securing element can be provided by machining. As indicated by block 1322, the additional securing element can be provided in various other ways.

At block 1324 a pre-orifice element 1062, a sealing element 1064, and a tip piece 1060 is provided.

In one example, as indicated by block 1326, providing the pre-orifice element 1062 can comprise forming (e.g., by machining, etc.) the pre-orifice element 1062 in the tip body 1034, such as the example pre-orifice portion 262 in the tip body 234 in FIG. 6 or the example pre-orifice portion 862 in the tip body 834 in FIG. 12. In such examples, providing the sealing element 1064 and providing the tip piece 1060 can comprise placing the sealing element 1064 and the tip piece 1060 into the receiving channel 1036 (from the front of the tip body as indicated by block 1332). In such examples, the tip piece 1060 is upstream of the pre-orifice element 1062 and the tip piece 1060, or at least a portion of the tip piece 1060, is upstream of the sealing element 1064. In such examples, the sealing element 1062 is upstream of the pre-orifice element 1062, or at least a portion of the pre-orifice element 1062. In such examples, the pre-orifice element 1062, or at least a portion of the pre-orifice element 1062, is upstream of the receiving channel 1036.

In one example, as indicated by block 1328, providing the pre-orifice element 1062 can comprise placing the pre-orifice element in the receiving channel 1036, such as the example pre-orifice pieces 162, 362, 462, 562, 662, and 762 in FIGS. 5 and 7-11, respectively. In such examples, providing can comprise placing the sealing element 1064 and the tip piece 1060 into the receiving channel 1036 (from the front of the tip body as indicated by block 1332 or from the back of the tip body as indicated by block 1334). In such examples, the tip piece 1060 is upstream of the pre-orifice element 1062 and the tip piece 1060, or at least a portion of the tip piece 1060, is upstream of the sealing element 1064. In such examples, the sealing element 1062 is upstream of the pre-orifice element 1062, or at least a portion of the pre-orifice element 1062. For instance, in some examples, the sealing element 1064 may be disposed around the pre-orifice element 1062 such that a portion of the sealing element is disposed in a hole of the sealing element 1064. In such examples, the pre-orifice element 1062, or at least a portion of the pre-orifice element 1062, is downstream of the receiving channel 1036.

In some examples, two or more of the pre-orifice element 1062, the sealing element 1064, and the tip piece 1060 may be provided together (e.g., placed in the receiving channel 1036 together), as indicated by block 1330. For instance, the sealing element 1064 and the pre-orifice element 1062 can, in some examples, be provided together (e.g., placed in the receiving channel 1036 together). For instance, the sealing element 1064 may be fit around a portion of the pre-orifice element 1062 and then the sealing element 1064 and the pre-orifice element 1062 may be provided together (e.g., placed in the receiving channel 1036 together). For instance, in the examples shown in FIGS. 5 and 11, the sealing element 1064 and the pre-orifice element 1062 may be provided together (e.g., placed in the receiving channel 1036 together). Of course, in instances, the sealing element 1064 and the pre-orifice element 1062 need not be provided together. For instance, the sealing element 1064 and the pre-orifice element 1062 need not be provided together in the examples shown in FIGS. 5 and 11.

In some examples, the pre-orifice element 1062, the sealing element 1064, and the tip piece 1060 may be provided separately. For instance, in the examples shown in FIGS. 6-10 and 12, the pre-orifice element 1062, the sealing element 1064, and the tip piece 1060 may be provided separately.

The pre-orifice element 1062, the sealing element 1064, and the tip piece 1060 may be provided in various other ways, as indicated by block 1336.

At block 1340 an additional securing element 1042 is provided to secure at least tip piece 1060 and sealing element 1064 (and in some examples also pre-orifice element 1062) within receiving channel 1036 and to form seals. In some examples, the additional securing element 1042 is provided to secure the pre-orifice element 1062, the sealing element 1064, and the tip piece 1060 in the receiving channel, such as in the examples shown in FIGS. 5 and 7-11 (e.g., examples where the pre-orifice element 1062 is a pre-orifice piece, such as pre-orifice piece 162, pre-orifice piece 362, pre-orifice piece 462, pre-orifice piece 562, pre-orifice piece 662, or pre-orifice piece 762, respectively). In some examples, the additional securing element 1042 is provided to secure only the tip piece 1060 and the sealing element 1064 in the receiving channel 1036, such as in the examples shown in FIG. 6 and FIG. 12 (e.g., examples where the pre-orifice element 1062 is a pre-orifice portion formed in the tip body 1034, such as pre-orifice portion 262 and pre-orifice portion 862, respectively). Providing the additional securing element 1042 causes the formation of seals by causing compression of sealing element 1064 (e.g., by driving movement of the tip piece 1060 or the pre-orifice portion 1062 to reduce the distance between the tip piece 1060 and the pre-orifice element 1062). The seals can include two or more of a seal between sealing element 1064 and pre-orifice element 1062, a seal between sealing element 1064 and tip piece 1060, and a seal between sealing element 1064 and tip body 1034.

In some examples, providing the additional securing element 1042 at block 1340 can comprise deforming a portion of the tip body 1034, as indicated by block 1342, such as in the examples of deformed projections 142 and 242 shown in FIGS. 5 and 6, respectively, and in the examples of deformed walls 742 and 842 shown in FIGS. 11 and 12, respectively.

In some examples, providing the additional securing element 1042 at block 1340 can comprise providing threads of a pre-orifice element 1062, such as in the example of threads 363 of pre-orifice piece 336 shown in FIG. 6. In such an example, the threads of the pre-orifice element 1062 are mated with threads of the tip body 1034 (e.g., threads 337) such as those provided at block 1314. The pre-orifice element 1062 is thus threadably coupled to the tip body 1034 and acts as an additional securing element 1042 to secure pre-orifice portion 1062, tip piece 1060, and sealing element 1064 in the receiving channel 1036. Thus, providing the pre-orifice portion 1062 and the additional sealing element 1042 at block 1340 can occur together as indicated by arrow 1038.

In some examples, providing the additional securing element 1042 at block 1340 can comprise deforming a portion of the pre-orifice element 1062, as indicated by block 1346, such as in the example of deformed wall 442 shown in FIG. 8. In such an example, the deformed portion of pre-orifice element 1062 may be deformed to be disposed within a recess (e.g., recess 440) of the tip body 1034 and to be disposed against another securing element 1042, such as a shoulder of the tip body 1034 (e.g., shoulder 443) such as the shoulder of the recess provided at block 1316.

In some examples, providing the additional securing element 1042 at block 1340 can comprise providing a ring, as indicated by block 1348, such as in the example of ring 565 and ring 665 show in FIGS. 9 and 10, respectively. In one example, the ring (e.g., ring 565) is moveable between a first diameter and a second diameter. The ring is caused to compress to the first, smaller diameter, until aligned with a recess (e.g., recess 540) wherein the ring will snap back to its second, larger diameter, to be disposed in the recess and disposed against another securing element 1042, such as a shoulder of the tip body (e.g., shoulder 543) such as the shoulder of the recess provided at block 1316. In another example, a portion (e.g., wall 667) of the ring (e.g., ring 665) is deformed to be disposed with a recess (e.g., recess 640) of the tip body 1034 and to be disposed against another securing element 1042, such as a shoulder of the tip body 1034 (e.g., shoulder 643) such as the shoulder of the recess provided at block 1316.

Providing the additional securing element 1042 at block 1340 can include the use of a tool, as indicated by block 1350, such as a swaging tool (e.g., swaging tool 190 or swaging tool 290), a rotatable driving tool (e.g., rotatable driving tool 390), a press tool (e.g., press tool 490, press tool 590, or press tool 690), a peen tool (e.g., peen tool 790 or peen tool 890), or another type of tool.

Providing the additional securing element 1042 to secure at least the tip piece 1060 and the sealing element 1064 (and in some examples also the pre-orifice element 1062) within the receiving channel 1036 and to form seals at block 1340 can be done in various other ways, as indicated by block 1352.

As can be seen, a spray tip can include a tip body (e.g., tip stem) having a longitudinal axis and a receiving channel, formed in the tip stem transverse to the longitudinal axis. The spray tip can further include a tip piece disposed within the receiving channel, a sealing element disposed within the receiving channel and upstream of the tip piece, and a pre-orifice element upstream of the tip piece. The spray tip can also include a fluid channel of variable geometry extending between an upstream end of the pre-orifice element and a downstream end of the tip piece. The spray tip can further include a first securing element downstream of the tip piece, or at least a portion of the tip piece and downstream of the sealing element, and a second securing element upstream of the sealing element, or at least a portion of the sealing element, and upstream of the tip piece. In one example, the second securing element is upstream of the pre-orifice element. In one example, the sealing element forms a portion of the fluid channel. In one example, the first securing element comprises a shoulder of the tip body defined by the receiving channel. In one example, the first securing element comprises a deformed portion of the tip body. In one example, the second securing element comprises a shoulder of the tip body defined by the receiving channel. In one example, the second securing element comprises a deformed portion of the tip body. In one example, the second securing element comprises a ring. In one example, the second securing element comprises threads of the pre-orifice element and threads of the tip body. In one example, the second securing element comprises a deformed portion of the pre-orifice element. In one example, the tip body includes a recess extending radially from the receiving channel, the recess configured to receive the second securing element. In one example, the recess includes a shoulder. In one example, the second securing element abuts the shoulder of the recess. In one example, the pre-orifice element comprises hardened stainless steel. In one example, the receiving channel includes threads and the pre-orifice element includes threads, the threads of the pre-orifice element and the threads of the receiving channel being configured to mate. In one example, the pre-orifice element comprises a set screw. In one example, the pre-orifice element is configured to receive a press tool to deform the portion of the pre-orifice element to form the second securing element. In one example, the pre-orifice element is configured to receive a rotatable drive tool. In one example, the pre-orifice element is configured to receive a biased element of a swaging tool. In one example, the tip piece is configured to receive a biased element of a swaging tool. In one example, the tip body is configured to receive a swaging tool to deform the portion of the tip body to form the first securing element. In one example, the tip body is configured to receive a swaging tool to deform the portion of the tip body to form the second securing element. In one example, the second securing element is configured to receive a press tool to cause the second securing element (e.g., ring, portion of pre-orifice element) to be disposed in a recess and to abut a shoulder of the recess. In one example, the tip body is configured to receive a peen tool to deform the portion of the tip body to form the second securing element. In one example, the, the tip body is configured to receive a peen tool to deform the portion of the tip body to form the first securing element.

Although the present invention has been described with reference to preferred examples, workers skilled in the art will recognize that changes may be made in form and detail without departing from the spirit and scope of the invention.

Additionally, while a particular order of steps has been described for the sake of illustration, it is to be understood that some or all of these steps can be performed in any number of orders.

It should also be noted that the different examples described herein can be combined in different ways. That is, parts of one or more examples can be combined with parts of one or more other examples. All of this is contemplated herein.

What is claimed is:

1. A spray tip comprising:
a tip body having a longitudinal axis;
a receiving channel extending between a front and a back of the tip body transverse to the longitudinal axis;
a tip piece;
a pre-orifice element;
a sealing element between the tip piece and the pre-orifice element, at least the tip piece and the sealing element disposed in the receiving channel, the tip piece defining a first portion of a fluid channel, the fluid channel extending from an inlet to an outlet;
a first securing element downstream of at least a portion of the tip piece and downstream of the sealing element; and
a second securing element upstream of at least a portion of the sealing element and the tip piece, wherein the first securing element and the second securing element secure at least the tip piece and the sealing element within the receiving channel.

2. The spray tip of claim 1, wherein the pre-orifice element comprises a pre-orifice piece, the pre-orifice piece disposed in the receiving channel upstream of the tip piece and defining a second portion of the fluid channel, and wherein the first securing element and the second securing element secure the tip piece, the sealing element, and the pre-orifice piece in the receiving channel.

3. The spray tip of claim 2, wherein the first securing element comprises a shoulder of the tip body.

4. The spray tip of claim 2, wherein the first securing element comprises a deformed portion of the tip body.

5. The spray tip of claim 2, wherein the second securing element comprises a deformed portion of the tip body.

6. The spray tip of claim 2, wherein the second securing element comprises a ring.

7. The spray tip of claim 2, wherein the second securing element comprises a deformed portion of the pre-orifice piece.

8. The spray tip of claim 2, wherein the second securing element comprises threads on an exterior surface of the pre-orifice piece, the threads on the on the exterior surface of the pre-orifice piece configured to mate with threads on a surface of the receiving channel.

9. The spray tip of claim 1, wherein the pre-orifice element comprises a pre-orifice portion formed in the tip body and upstream of the receiving channel.

10. The spray tip of claim 9, wherein the first securing element comprises a deformed portion of the tip body.

11. The spray tip of claim 9, wherein the second securing element comprises a shoulder of the tip body.

12. A fluid application system comprising:
a fluid applicator;
a fluid delivery line coupled to the fluid applicator;
a pump configured to deliver fluid from a fluid source through the fluid delivery line to the fluid applicator; and
a spray tip coupled to the fluid applicator, the spray tip comprising:
a tip body having a longitudinal axis;
a receiving channel extending between a front and a back of the tip body transverse to the longitudinal axis;
a tip piece;
a pre-orifice element;
a sealing element between the tip piece and the pre-orifice element, at least the tip piece and the sealing element disposed in the receiving channel, the tip piece defining a first portion of a fluid channel, the fluid channel extending from an inlet to an outlet;
a first securing element downstream of at least a portion of the tip piece and downstream of the sealing element; and
a second securing element upstream of at least a portion of the sealing element and the tip piece, wherein the first securing element and the second securing element secure at least the tip piece and the sealing element within the receiving channel.

13. The spray tip of claim 12, wherein the pre-orifice element comprises a pre-orifice piece, the pre-orifice piece disposed in the receiving channel upstream of the tip piece and defining a second portion of the fluid channel, and wherein the first securing element and the second securing element secures the tip piece, the sealing element, and the pre-orifice piece in the receiving channel.

14. The spray tip of claim 13, wherein the first securing element comprises a portion of the tip body.

15. The spray tip of claim 13, wherein the second securing element comprises a portion of the tip body.

16. The spray tip of claim 13, wherein the second securing element comprises a ring, the spray tip further comprising a third securing element against which the second securing element is disposed.

17. The spray tip of claim 13, wherein the second securing element comprises a deformed portion of the pre-orifice piece, the spray tip further comprising a third securing element against which the second securing element is disposed.

18. The spray tip of claim 12, wherein the pre-orifice element comprises a pre-orifice portion formed in the tip body and upstream of the receiving channel.

19. The spray tip of claim 18, wherein the first securing element comprises a first portion of the tip body and the second securing element comprises a second portion of the tip body.

20. A method of manufacturing a spray tip comprising:
providing a tip body having a longitudinal axis;
providing a receiving channel in the tip body transverse to the longitudinal axis, wherein providing the receiving channel provides a securing element;
providing a pre-orifice element;
providing a sealing element, wherein providing the sealing element comprises providing the sealing element within the receiving channel upstream of at least a portion of the pre-orifice element;
providing a tip piece, wherein providing the tip piece comprises providing the tip piece within the receiving channel; and
providing an additional securing element, wherein providing the additional securing element drives movement of at least one of the tip piece or the pre-orifice element and compresses the sealing element to form a plurality of seals.
